(19) United States
(12) Patent Application Publication
(10) Pub. No.: US 2021/0138537 A1
(43) Pub. Date: May 13, 2021

(54) BATH TRANSFER SYSTEM FOR RECEIVING, TRANSPORTING AND CONVEYING MOLTEN METAL

(71) Applicant: STRIKOWESTOFEN GMBH, GUMMERSBACH (DE)

(72) Inventors: FLORIAN KULAWIK, FRIEDBERG (DE); THEODOOR VAN DER HOEVEN, KOELN (DE); MICHAEL VIEDENZ, GUMMERSBACH (DE)

(73) Assignee: STRIKOWESTOFEN GMBH, GUMMERSBACH (DE)

(21) Appl. No.: 16/961,280

(22) PCT Filed: Jan. 11, 2019
(86) PCT No.: PCT/EP2019/050706

§ 371 Date: Jan. 22, 2021

(30) Foreign Application Priority Data
Jan. 12, 2018 (EP) 18151506.5

(51) Int. Cl. B22D 17/30; F27D 3/14

(52) U.S. Cl. CPC B22D 17/30; B22D 39/06; F27D 3/14

(57) ABSTRACT

The present application relates to a bath transfer system having a vessel for receiving molten metal, a duct for conveying the molten metal from the vessel through the duct, a vessel cover for air-tightly sealing a vessel interior, and a control unit for controlling the conveying of the molten metal from the vessel through the duct. The control unit being designed and configured to stop the molten metal from continuing to be conveyed in the event of a drop in the measured pressure. An associated control process is also included.

The present application relates to a melt transfer system for receiving, transporting and feeding molten metal. The present invention furthermore relates to a corresponding method.

Transportable systems by way of which molten metal can be received and transferred are known from prior art. JP4190786, for example, shows a transport vessel to which molten metal can be fed. The molten metal can be transported in the vessel and fed out of the vessel by way of a set pressure difference between the interior of the vessel and the surrounding area.

So as to apply the pressure difference for emptying the vessel, for example, air can be introduced under pressure into the interior of the vessel. As a result, pressure can be applied to the molten metal present in the vessel so that the molten metal rises in a flow duct, in particular a riser, connecting the interior of the vessel and the surrounding area and can be fed out of the vessel. The pressure is typically increased steadily in the process, so that the molten metal is fed through the flow duct or the riser to the outside. At a point in time at which the molten metal present in the furnace has already been largely fed from the interior to the outside, the molten metal being fed to the outside may mix with air during emptying of the vessel. The hot molten metal can be drastically accelerated as a result of the admixed air, so that the molten metal may splash uncontrolled at an outlet of the holding furnace. Such hot molten metal splash is dangerous, in particular for operating staff, but also for sensitive devices present in the surrounding area of the transportable vessel.

In JP4190786, the filling process and the emptying process of the melt transfer device are controlled by a control unit, which analyzes the weight data of the melt transfer device. Based on the weight of the melt transfer device, it can be established how much molten metal is present in the vessel of the device. When the control unit establishes that the molten metal in the interior of the melt transfer device is running low, an emptying process of the vessel of the melt transfer device is ended.

It is the object of the present invention to provide an alternative melt transfer system. It is preferably an object of the present invention to provide a melt transfer system that enhances the occupational safety for operating staff and facilitates the work of operating staff. It can be a further object of the present invention to provide a corresponding method that achieves this object.

The above object is achieved by a method and/or a melt transfer system according to claim 1 and an additional independent claim. Advantageous refinements are described in the dependent claims.

The melt transfer system can be used to receive, transport and transfer hot molten metal into another vessel or into a furnace. For this purpose, the melt transfer system comprises a transportable vessel for receiving the molten metal, a vessel cover arranged on the vessel for closing the vessel in an air-tight manner, and a flow duct. The vessel cover preferably includes a closable filling opening for filling the vessel with the molten metal and a corresponding filling opening cover. As an alternative, the vessel cover can comprise a filling device for filling the vessel with molten metal through a filling pipe or through the flow duct.

The flow duct can, for example, be designed as a flow line or as a pipe, and preferably as a riser. The flow duct can have round or angular cross-sections. The flow duct preferably comprises a refractory material so that hot molten metal can flow through the flow duct. The flow duct has a first end arranged in the vessel, and a second end arranged outside the vessel for feeding the molten metal from the molten metal vessel. The melt transfer system preferably comprises a pneumatic unit for introducing air into the vessel. The air is introduced into the vessel under pressure. The pressure can be at least 0.1 bar, and preferably at least 0.2 bar.

Molten metal can be pushed out of the vessel through the flow duct or the riser and fed out of the vessel by way of a pressure difference between a pressure prevailing in the vessel and ambient pressure prevailing outside thereof. So as to maintain the feeding process when the vessel is being emptied, the pressure difference is typically increased. The feeding process can be interrupted or ended by lowering, or completely eliminating, the pressure difference. A control of the pressure application and a setting of the pressure difference can be manually settable by an operator. Preferably, however, a control unit controls the emptying of the vessel by setting the pressure difference between the first and second ends of the flow duct. The control unit controls a pneumatic unit, for example, which is designed to apply air pressure to the vessel interior.

In contrast to the teaching of JP4190786, the melt transfer system of the present application can comprise, in addition or as an alternative to the weight measuring device measuring the weight of the content of the vessel, a pressure measuring unit for measuring a pressure in the vessel during the feeding. The pressure measuring unit preferably comprises at least one pressure sensor.

The melt transfer system of the present application can furthermore comprise a control unit for controlling the feeding of the molten metal out of the vessel through the flow duct. The control unit can be configured and designed, for example, to control a pneumatic unit, which, in turn, is designed to apply air pressure to the vessel interior.

In contrast to the control device of JP4190786, the control unit of the present application is not, or not exclusively, designed and configured to analyze weight data of the melt transfer device, and to control the filling process and the emptying process of the melt transfer device based on the ascertained weight. Rather, the control unit of the present application can be configured and designed to control the feeding of the molten metal based on the pressure measured by the pressure measuring device. It is, in particular, configured and designed to halt the feeding of the molten metal in the event of a drop of the measured pressure.

The control unit can furthermore be configured to determine a pressure profile over time from the pressure measured by the measuring unit. Based on the pressure profile over time, it is possible, for example, to ascertain the drop of the measured pressure. For this purpose, the control unit can be configured and designed to halt the feeding of the molten metal when a pressure difference between a pressure determined at a first point in time and a pressure determined at a second point in time is negative, wherein the negative pressure difference is preferably greater, in absolute terms, than a previously established threshold value. The first point in time is earlier compared to the second point in time, the second point in time being accordingly later than the first point in time.

The control unit can be designed and configured to ascertain the pressure difference by subtracting the pressure at the first point in time from the pressure at the second point in time.

So as to at least partially empty the melt transfer system, the molten metal can be fed out of the vessel through the flow duct. To this end, the control unit, for example, sets the pressure difference between the first and second ends of the flow duct. During the feeding, a pressure can be determined in the vessel, preferably by way of the control unit and a measuring unit comprising at least one pressure sensor. For example, the pressure can be measured directly in the vessel or in the aforementioned pneumatic unit. The pressure sensors are preferably arranged so as to measure the pressure of a vessel interior space in which the molten metal is located. The pressure sensors preferably do not make contact with the molten metal in the process. The at least one pressure sensor can be arranged on an inner side of the vessel cover, or in a pneumatic unit. The control unit can determine the pressure in the vessel from the measured pressure.

The feeding of the molten metal can be halted when a pressure difference between a pressure determined at a first point in time and a pressure determined at a second point in time is negative, wherein the negative pressure difference is preferably greater, in absolute terms, than a previously established threshold value. The first point in time is earlier compared to the second point in time, the second point in time being accordingly later than the first point in time. The pressure difference is ascertained by subtracting the pressure at the first point in time from the pressure at the second point in time. The threshold value is preferably, in absolute terms, at least 1 mbar, and particularly preferably at least 2 mbar, wherein the threshold value can be selected depending on the time lag between the first and second point in time.

A pressure profile over time can be determined based on the determined pressure. In particular, the control unit can be configured and designed to determine this pressure profile over time. This pressure profile over time can be recorded and monitored, for example by the control unit designed and configured for this purpose. The control unit typically carries out the control in such a way that air is continuously supplied to the vessel for continuously emptying the vessel so that the pressure in the vessel increases. The feeding of the molten metal can be halted in the event of a drop of the measured pressure. The control unit can be configured and designed to record and register such a pressure drop, and to thereupon halt the feeding of the molten metal. For this purpose, the control unit can control the pneumatic unit so as not to apply further pressure to the vessel and/or vent the vessel, so that the pressure difference remains constant or drops.

The control unit is designed and configured to carry out the control process steps described hereafter, and to halt the feeding of the molten metal, in particular by control of the pneumatic unit. Based on the pressure profile over time, the control unit is able to ascertain a pressure difference between at least two consecutive pressures. The feeding of the molten metal can in particular be halted when the pressure difference is negative, that is, when the pressure ascertained later is lower than the pressure ascertained earlier, or when the mean value of two or more pressures ascertained later is lower than the mean value of two or more pressures ascertained earlier.

The pressures can be measured at defined time intervals. The intervals are preferably identical. The time intervals between the pressure measurements can, for example, be a maximum of 500 ms, preferably a maximum of 100 ms, and particularly preferably a maximum of 50 ms. The control unit can be designed and configured to carry out the pressure measurement at the intervals, and to register the pressure values. The control unit can be designed and configured to set the time intervals of the measurements.

The time derivative dp/dt of the pressure profile can be ascertained from the pressures measured at defined time intervals. The feeding of the molten metal can, in particular, be halted when the derivative dp/dt is negative. A threshold value S can preferably be determined prior to or during the feeding of the molten metal, so that the feeding of the molten metal is only halted when the derivative is smaller than the threshold value S, wherein the threshold value S is smaller than zero. One criterion for halting the feeding of the molten metal can thus be when dp/dt<0 applies, or when additionally dp/dt<S<0 applies. The threshold value S can be ascertained empirically, for example. A threshold value has the advantage that minor pressure fluctuations, for example due to vortex effects, friction losses and/or measuring inaccuracies, do not necessarily result in an immediate shutdown of the feeding of the molten metal. The threshold value should, on the one hand, be selected so that minor pressure fluctuations do not result in a shutdown, but, on the other hand, it is to be established by way of the threshold value that the molten metal level inside the vessel is near the first end of the flow duct. The feeding of the molten metal can preferably be shut off when air penetrates into the first end of the flow duct, and before the air reaches the second end of the flow duct. In the pressure profile over time, this point in time, when air penetrates into the first end of the flow duct, is marked by a pressure drop. The pressure profile at this very point in time typically has a time derivative that, in absolute terms, is greater than 1 mbar/s. As a result, a threshold value can advantageously be, in absolute terms, at least 1 mbar/s, preferably at least 5 mbar/s, and particularly preferably at least 10 mbar/s. Typically occurring vortex effects or manual, brief interruptions in the feeding can be taken into consideration with the threshold value and be included in a threshold value ascertainment.

A deviation or tolerance of the shutdown is preferably no more than 4% of a fill weight of the vessel with molten metal. Particularly preferably, a deviation is no more than 2% of a fill weight of the vessel with molten metal.

A second pressure can be measured in a second location so as to identify measuring errors. The second measured pressure preferably correlates with a pressure in the vessel, with a pressure in the pneumatic unit for setting a pressure difference between an ambient pressure and a pressure in the vessel and/or with a pressure in the flow duct. For example, the second pressure can be compared to the first measured pressure for agreement or correlation.

In each case, at least two, and preferably at least three, consecutively measured pressures can be averaged. The time derivative dp/dt can then be ascertained based on the averaged pressures. In this way, the derived pressure curve can be smoothed, so that fluctuations and measured value outliers can be counteracted. In this way, the functional reliability of the evaluation can be increased. The control unit can preferably be configured and designed to average the measured values and/or to determine a pressure profile over time based on the averaged measured values.

The pressure profile over time can also be filtered with respect to the frequency thereof. For example, a bandpass filter, and in particular a bandpass filter having the frequencies 5 Hz and 25 Hz, can be used for this purpose. The amplitude of the filter output signal can be used as a shutdown criterion. The control unit can preferably be configured and designed to control a feeding of a molten metal based on the output signal of the bandpass filter.

So as to halt the feeding of the molten metal, the pressure difference between a pressure prevailing in the vessel and an ambient pressure prevailing outside thereof can be reduced, in particular as soon as the ascertained derivative of the pressure profile is negative and preferably, in absolute terms, is greater than the previously established threshold value. The control unit can be configured and designed to set this pressure difference and, in particular, to reduce it for halting the feeding of the molten metal.

The control unit can furthermore be designed and configured to determine the time profile over time p(t) from the measured pressure, to ascertain the time derivative of the pressure profile dp/dt, and to halt the feeding of the molten metal when the derivative of the pressure profile dp/dt is negative, and preferably when the derivative, in absolute terms, is greater than the previously established threshold value.

In the described melt transfer system, typically some melt remains in the vessel after the described emptying process. As a result, this residual melt may block, or even destroy, the flow duct after having cooled and solidified. The blocking of the first end of the flow duct can in particular be problematic during renewed heating of the solidified melt, since the flow duct, in particular in the form of a riser, can advantageously serve as a chimney when heating the described melt transfer system. It can therefore be an object of the invention to prevent this problem.

For this purpose, the melt transfer system can comprise an oblique positioning device for tilting the vessel. The vessel can be tilted by way of the oblique positioning device in such a way that the remaining melt at the bottom of a vessel inner side flows into a side facing away from the first end of the flow duct. The first end of the flow duct can thus be displaced upwardly with respect to a plane on which the melt transfer system is located. In this way, the remaining melt can expose the first end of the flow duct and solidify in the vessel. During renewed heating of the vessel interior space, for example by way of a gas burner, the flow duct, in particular in the form of a riser, can thus be used as a chimney. This may be advantageous, in particular, compared to electrically preheating approaches from the prior art, since the flow duct, or the riser, is likewise heated in the process. In this way, a solidification of melt in the flow duct, or in the riser, can be counteracted. Melt that has solidified in the flow duct, or in the riser, can lead, at least regionally, to clogging of the flow duct, or of the riser, during a feeding of the molten metal. It can thus be the object of the described melt transfer system to improve a molten metal transfer.

The oblique positioning device can comprise at least one base connected to the vessel in an articulated manner, and a vessel-side locking device for locking the base in a functional position. The base can be connected to the vessel directly or indirectly, for example via at least one component coupled to the vessel. The base can be brought from an idle position into a functional position, wherein the base can protrude over a vessel underside in the functional position. The melt transfer system can also comprise multiple oblique positioning devices. It may be particularly advantageous if at least two oblique positioning devices that are spaced apart from one another are present, which each comprise at least one base. In this way, the melt transfer system can, for example, be tilted in a statically determinate manner.

The vessel-side locking device can comprise a detent, clamping or snap-fit mechanism or a locking pin. Other locking mechanisms are, of course, also conceivable.

In one embodiment, the vessel can comprise a first flange including a first flange-side borehole. The base can include a first base-side borehole, which is aligned coaxially to the first flange-side borehole in the functional position. In this way, for example, the locking pin can be pushed through the first flange-side borehole and the first base-side borehole for locking the base in the functional position. The locking pin can accordingly be designed in such a way that a pin diameter corresponds to a diameter of the first flange-side borehole and the first base-side borehole. A diameter of the locking pin can, for example, be at least 10 mm, and preferably at least 15 mm. The locking pin, the base and/or the flange are preferably made of steel.

The flange can preferably be welded to the vessel. The flange can also be joined to the vessel in another manner, for example by way of a screw joint or a plug connection.

The base can include a second base-side borehole, which is aligned coaxially to the first flange-side borehole in the idle position. The locking pin can thus be pushed through the first flange-side borehole and the first base-side borehole for locking the base in the idle position.

The base can be pivotable from the idle position into the functional position, and vice versa. A pivoting can have the advantage that a defined movement option of the base is predefined, which is easy for an operator to comprehend and carry out. The base can furthermore be pivotably connected to the vessel in such a way that no loose individual parts can be lost. The base can, of course, also be designed to be unscrewed, folded out or extended, for example in a telescoping manner.

In one embodiment, the oblique positioning device can comprise a fastening pin that rotatably connects the base to the flange. A rotational axis can be defined along a fastening pin longitudinal direction, about which the base can be pivoted from the idle position into the functional position, and vice versa. The fastening pin can simply be pushed into the flange-side borehole or boreholes, or comprise a bearing, for example a ball bearing. The fastening pin can be rigidly connected to the flange, or rigidly connected to the base, or rotatably connected to the base and the flange.

In an advantageous embodiment, the oblique positioning device can comprise a second flange, which is preferably designed to correspond to the first flange. The base can then, in particular, be arranged between the two flanges. This can increase a stability of the oblique positioning device.

In one embodiment, the melt transfer system can comprise a supporting frame comprising a swivel joint unit. The vessel can be pivotably connected to the supporting frame by way of the swivel joint unit in such a way that the vessel can be tilted about a rotational axis of the swivel joint unit in relation to the supporting frame. In the tilted position, the vessel can be supported by the base locked in the functional position. This can have the advantage that the vessel can be tilted by the same angle substantially independently of an uneven floor on which the melt transfer system is located. The vessel can be tilted in relation to the supporting frame by way of the oblique positioning device by an angle of at least 1°, preferably at least 3°, and particularly preferably at least 5°. The vessel can be tilted in relation to the supporting frame by way of the oblique positioning unit by an angle of no more than 30°, preferably no more than 10°, and particularly preferably no more than 6°. In this way it can be ensured that the flow duct, in particular in the form of a riser, cannot be clogged and/or destroyed by cooling residual melt.

In one embodiment, the supporting frame can comprise a supporting frame-side locking device for locking the base in the functional position. Similarly to the vessel-side locking mechanism, this locking mechanism can, for example, be designed as a detent, clamping or snap-fit mechanism or, for example, comprise a further locking pin. It is also possible to use a combination of different locking mechanisms, both for the vessel-side and for the lower, supporting frame-side locking device. As a result of the supporting frame-side locking mechanism, the vessel can be transported in the tilted position. Furthermore, a more secure footing and safer transport can be ensured in the functional position.

The base can include a third borehole, which can be designed to receive a second locking pin in the functional position. The lower locking device can include at least one supporting frame-side borehole, which can be arranged coaxially with the third base-side borehole in the functional position. In this way, the second locking pin can be pushed into the third base-side borehole and the supporting frame-side borehole of the lower locking device for fastening the base to the lower supporting frame.

In one embodiment, the supporting frame can comprise at least one pair of, preferably box-shaped, fork pockets for receiving forklift truck tines. In this way, the melt transfer system can be transported in a simple manner. The melt transfer system can furthermore be raised in a simple manner. In the raised position, the oblique positioning device can be moved from an idle position into a functional position in a simple manner. In particular, the melt transfer system can, in this way, be brought by a single operator into a tilted position in a simple manner. The fork pockets can preferably be box-shaped, and in particular at least two boxes can be provided. It is also possible for a box comprising rails or a rib-like separation to be provided so as to guide the forklift tines during the insertion into the fork pockets. Particularly advantageously, it may be provided that the fork pockets are designed in such a way that a forklift truck can approach the melt transfer system from four sides and pick it up.

The melt transfer system can furthermore comprise an alignment device for setting a vessel inclination and/or a supporting frame inclination. This alignment device can preferably be provided in addition to an oblique positioning device. For example, the alignment device can comprise at least three threaded rods, which can each comprise feet that can be adjustable in a height, preferably independently of one another. In this way, the melt transfer system can be aligned on an uneven floor so that the melt transfer system can have a uniform melt level, for example, compared to the vessel inner side bottom during operation.

The vessel of the melt transfer system can be tilted or obliquely positioned as follows. Initially, the melt transfer system can be raised to such an extent that the base can be brought into a functional position. The melt transfer system can be raised at least 5 cm, and preferably at least 10 cm in the process. Furthermore, a raising of no more than 30 cm may be advantageous. So as to facilitate an operability for a user, the device, however, can also be raised considerably higher, so that the user, for example, does not have to bend down to bring the base into the functional position. In this way, ergonomical working can be enhanced. Thereupon, the base can be brought from an idle position into a functional position in such a way that the base protrudes over an underside of the vessel. The base can be locked in the functional position. Thereafter, the melt transfer system can be lowered. The raising and lowering of the melt transfer system can preferably be carried out by way of a forklift truck. Prior to lowering, the base is preferably locked in relation to the supporting frame by way of the supporting frame-side locking device.

In known systems for preheating transport vessels, the entire vessel cover has to be removed from the vessel for preheating. For example, a relatively heavy cover, corresponding to the vessel cover in terms of the size thereof, can then be placed on, the cover comprising an integrated burner. In other known systems, the preheating takes place by way of electrical heating elements. Both approaches are associated with a lot of effort.

It is the object of the system described here to preheat the transport vessel together with the vessel cover and with the preferably complete flow duct or riser, wherein the effort for setting up the heating is comparatively low. For this purpose, the vessel cover of the melt transfer system can include a heating opening, comprising a connecting flange surrounding the heating opening for flange-mounting a preheating device and for flange-mounting a heating opening cover, and a heating opening cover for closing the heating opening in an air-tight manner. So as to preheat the transport vessel and the flow duct or riser, hot gases are introduced through the heating opening into the vessel, wherein the hot gases are generated by a gas burner, for example. The hot gases are discharged through the flow duct or the riser into the surrounding area, and thus also preheat the flow duct or the riser. The heating opening cover can be detachably fastened to the vessel cover, for example by way of screws or clamps, and can close the heating opening in an air-tight manner. Such a heating opening has the advantage that a preheating device can be mounted on the vessel in a simple manner, and can then heat a melt solidified in the vessel and/or preheat a vessel interior space.

Moreover, it may be sufficient for preheating to remove the comparatively small heating opening cover, which is lightweight compared to the vessel cover, so as to heat the vessel interior space. A removal of the large vessel cover can thus be avoided.

The heating opening can be round, rectangular, or polygonal. The inner diameter or hydraulic diameter thereof (4*cross-sectional surface divided by the circumference) can be at least 4 cm, preferably at least 6 cm, and particularly preferably approximately 9 cm. It can maximally be half the inner diameter of the vessel opening, and preferably maximally 20 cm.

The heating opening can, for example, be maximally half as large as the filling opening. The heating opening can preferably be approximately ⅓ the size of the filling opening, and particularly preferably approximately ⅙ of the size of the filling opening.

The following numerical value information shall not be interpreted to be limiting, but only by way of example, and only show possible embodiments of the melt transfer system. The filling opening can have a diameter of at least 20 cm, and preferably at least 30 cm, and/or a diameter of no more than 100 cm, and preferably no more than 80 cm. The vessel cover can have a diameter of at least 50 cm, and preferably at least 70 cm, and/or a diameter of no more than 250 cm, and preferably no more than 175 cm.

The vessel cover, the filling opening cover and/or the heating opening cover can in particular comprise steel. Furthermore, the vessel cover, the filling opening cover and/or the heating opening cover can also comprise thermally insulating layers made of refractory materials, such as fiber mats and/or refractory concrete. The vessel cover, the filling opening cover and/or the heating opening cover can comprise the same or different materials. The heating opening cover can comprise a blind flange, for example, for closing the heating opening. The heating opening cover can be fastened to the vessel cover by way of clamps and/or screws. This has the advantage that the heating opening cover can be mounted to and be removed from the vessel cover in a simple manner.

In one embodiment, the connecting flange can project on a cover upper side in such a way that a flange plane is spaced apart from the cover upper side. A projecting flange can in particular facilitate a mounting of the burner on the flange. The flange structure can furthermore be better insulated.

The flange plane can form an angle with the cover upper side (angled flange-mounting plane). The angle can be formed in such a way that the imaginary extension of the axis of the flange-mounted burner strikes the surface of the solidified residual metal in the vessel. It can also be formed so as to strike the bottom of the vessel approximately in the center thereof. It can also be formed so as to have the maximum distance from the vessel walls at approximately half the height of the vessel (that is, alignment with the center of the vessel interior space).

The flange plane can form an angle with the cover upper side of at least 10°, preferably at least 20°, and particularly preferably at least 30°, and/or of no more than 90°, preferably no more than 80°, and particularly preferably no more than 70°. In one embodiment, the flange plane can also form an angle with the cover upper side of at least 40° or of at least 50°. An angled flange-mounting plane can have the advantage that a burner that is flange-mounted on the connecting flange can be aligned in the direction of a vessel interior space center, or in the direction of a vessel side, for example a region in which solidified residual melt is arranged.

In one embodiment, the heating opening cover can comprise a handle for better handling. This handle can, for example, be thermally insulated so that the cover can be operated by an operator even after the vessel interior space has been heated.

In one embodiment, the connecting flange can be designed in such a way that a corresponding flange of a preheating device, and in particular of a gas burner or of an electronic heating element, for preheating the vessel interior space can be flange-mounted on the flange by way of clamps or screws. This has the advantage that the preheating device can be mounted to and removed from the vessel cover in a simple manner.

The melt transfer system can comprise a burner cover that comprises a preheating device, preferably a gas burner, and a mounting flange that corresponds to the connecting flange of the heating opening.

Advantageous exemplary embodiments are shown in the figures. Only features of the different embodiments disclosed in the exemplary embodiments can be claimed combined with one another and individually.

Advantageous exemplary embodiments are shown in the figures. Only features of the different embodiments disclosed in the exemplary embodiments can be claimed combined with one another and individually.

In the drawings:

FIGS. 1 (a) to (d) show four perspective views of a melt transfer system;

FIG. 2 shows a schematic sectional view of the melt transfer system of FIG. 1;

FIG. 3 shows a schematic sectional view of the vessel that has been almost emptied, including residual molten metal present in the vessel;

FIGS. 4 (a) and (b) show an air/molten metal mixture in the riser;

FIG. 5 shows a pressure profile in the vessel during the feeding of the molten metal;

FIG. 6 shows a further pressure profile in the vessel during the feeding of the molten metal as well as a time derivative of the pressure profile;

FIG. 7 shows the pressure profile of FIG. 5, wherein the time derivative was smoothed with averaged pressures;

FIG. 8 shows the pressure profile of FIG. 5, wherein additionally the time has been taken into consideration;

FIG. 9 shows a schematic sectional representation of the melt transfer system;

FIGS. 10 (a) and (b) show the oblique positioning device in two perspective views;

FIG. 11 shows a section of the vessel comprising a supporting frame in a perspective view;

FIG. 12 shows the supporting frame in a further perspective view;

FIG. 13 shows the vessel with parts of the vessel-side oblique positioning device in a side view;

FIGS. 14 (a) to (f) show a schematic representation of the method steps for obliquely positioning the vessel by way of a forklift truck; and

FIG. 15 shows the burner unit in a perspective view.

FIG. 1 shows a melt transfer system 1 comprising a vessel 2 for receiving molten metal, a vessel cover 3 for closing the vessel 2 in an air-tight manner, a filling opening 4, and a filling opening cover 5. FIGS. 1 (a) and 1 (b) show the melt transfer system 1 from two different perspective views. FIG. 1 (c) shows the same view as FIG. 1 (b), the filling opening cover 5 being shown opened. The vessel 2 can be filled with hot molten metal through the filling opening 4. After a filling process, the filling opening 4 can be closed in an air-tight manner by the filling opening cover 5. A pressure can be applied to a vessel interior space 7 of the vessel 2 via a pneumatic unit 6. For this purpose, air is conducted from the pneumatic unit 6 at a pressure of 0.4 bar, for example, through a pneumatic unit 6.1 into the vessel interior space 7. The melt transfer system 1 furthermore comprises a flow duct in the form of a riser 8. When pressure is applied to the vessel interior space 7 by the pneumatic unit 6, a pressure difference arises between a first end 8.1 of the riser 8, which is arranged in the vessel 2, and a second end 8.2 of the riser 8, which is arranged outside the vessel 2. As a result of this pressure difference, the melt present in the vessel 2 is fed from the first end 8.1 to the second end 8.2, and the vessel 2 can be emptied. A thermocouple 9 for monitoring the temperature of the molten metal is furthermore arranged at the vessel cover 3, the thermocouple protruding into the vessel interior. The vessel cover 3 furthermore includes a heating opening 10 having a heating opening cover 10.1 arranged thereon. The melt transfer system 1 moreover comprises fork pockets 11 in which the forklift tines can engage. The fork pockets 11 are box-shaped and designed so as to be approachable from 4 sides. The melt transfer system furthermore comprises an oblique positioning device 12, comprising a base 12.2 and a supporting frame 12.1 including a swivel joint unit 12.1.1.

FIG. 2 shows a melt transfer system 1 of FIG. 1 in a sectional view along an xy-plane. Recurring features are denoted by identical reference numerals in this and the following figures. The vessel 2 includes an interior lining comprising a refractory compound 13. Viewed from the outside in, the vessel 2 then comprises an insulating layer 14. The outside cladding 15 of the vessel 2 is made of steel. In FIG. 2, a burner unit 10.2 is mounted on a connecting flange 10.3, instead of the heating opening cover 10.1. The burner unit 10.2 is preferably fixed to the vessel cover 3 by clamps. The connecting flange 10.3 projects from the vessel cover 3 and is inclined in relation to the xz-plane. The melt transfer system 1 furthermore comprises a control unit 16, which can communicate with the melt transfer system 1, and in particular with the pneumatic unit 6.

FIG. 3 shows a schematic sectional view of a vessel that has been almost emptied, including residual molten metal 17 present in the vessel. The molten metal can be aluminum, for example. The vessel is furthermore filled with air 18. Air 18 can penetrate into the riser 8 through a gap 19 between the first end 8.1 of the riser and the molten metal 17 having a gap height 19.1. This air/melt mixture in the riser 8 is shown in FIG. 4 (b). During a melt transfer process at a point in time at which the first end 8.1 of the riser 8 is completely immersed in molten metal 17, only molten metal 17 is present in the riser 8, as shown in FIG. 4 (a). When air 18 penetrates into the riser through the gap 19.1, the air 18 accelerates the molten metal 17 in the riser 8 in FIG. 4 (b) in such a way that hazardous metal splash arises at the second end 8.2 of the riser.

FIGS. 5 to 8 show exemplary pressure profiles 20 over the time during a feeding of molten metal. Based on such pressure profiles 20, the control unit 16 can prompt the feeding of the molten metal to be halted, that is, the emptying process of the vessel 2 to be halted, and thereby avoid the above-described metal splash. At the start of an emptying process of the vessel, the pneumatic unit 6 causes a pressure increase in the vessel. In the process, a measuring unit, that is, at least one pressure sensor, measures the pressure in the vessel 2. For this purpose, the pressure sensor can be mounted on a vessel cover underside 3.1, for example (see FIG. 2). The control unit 16 ascertains the pressure profile 20 p(t) from the measured pressures.

FIG. 5 shows a pressure profile during the transfer of the molten metal through the riser 8 from the first end 8.1 to the second end 8.2. The transfer begins at the end of area I, at the transition to area II, and metal flows out of the second end 8.2 of the riser 8. Area II corresponds to a vortex effect. A normal pressure increase during the feeding is shown in areas III and V. Area IV represents a pressure drop as a result of a brief interruption in the transfer by an operator. The emptying point is reached at the beginning of area IV, resulting in a drastic drop in pressure and a negative pressure difference: Δp=pᵢ−pᵢ₋₁≤0.

In areas II, IV and VI, negative derivatives dp/dt of the pressure profile p(t) arise due to the brief or longer-lasting pressure drops. In addition to the pressure profile 20, FIG. 6 shows the time derivative 21 of the pressure profile 20. This is determined by the control unit and is smaller than zero in area VI.

Smoothing of the time derivative curve 21 can be advantageous for a functionally reliable evaluation of the pressure values, so that incorrect evaluation results due to pressure fluctuations can be avoided to the extent possible. When a simple comparison of pᵢ and pᵢ₋₁ is carried out, the profile of the time derivative oscillates. For a smoothing of the pressure gradient, it is advantageous to average the last three or more pressure readings, so that the measured values measured by the pressure sensor are filtered. The control unit 16 is configured and designed to carry out this averaging. FIG. 7 shows the time derivative dp/dt filtered and is denoted by reference numeral 21f. The control unit can be designed to determine the filtered derivative as follows:

The more values are used for filtering, the smoother the profile of the time derivative becomes. A smoother profile, however, also causes the response time to become longer. The response time is the time that the control unit requires to identify the pressure drop.

The control unit can be designed to determine the filtered derivative as follows:

$$\frac{dp}{dt} = \frac{{ρ}_{t} - {ρ}_{t - 1}}{Δ t}$$

$$Δ t = {t}_{{p}_{t}} - {t}_{{p}_{t - 1}}$$

where

$$\begin{matrix}{p}_{t - 1} = \frac{1}{2} {\sum }_{i = 0}^{1} {P}_{i} = \frac{{p}_{0} + {p}_{1}}{2} \\ {p}_{t} = \frac{1}{2} {\sum }_{i = 1}^{2} {P}_{i} = \frac{{p}_{1} + {p}_{2}}{2} \\ {Δ p}_{t} = {p}_{t - 1} - {p}_{t}\end{matrix} .$$

This profile is illustrated in FIG. 8. The control unit is designed and configured to ascertain the time derivative of the pressure drop 20, and to shut off a feeding of molten metal through the riser 8 as soon as the derivative is smaller than zero. In particular, the control unit can be configured to only shut off the feeding of molten metal through the riser 8 when the derivative is smaller than zero, and the derivative, in absolute terms, is greater than a threshold value. This threshold value can be 12 mbar/s, for example.

After the feeding of molten metal 17 has been shut off, residual molten metal 17 typically remains in the vessel 2. So as to prevent this, after solidifying, from clogging the first end 8.1 of the riser 8, the melt transfer system 1 is advantageously equipped with an oblique positioning device 12. FIG. 9 shows a schematic sectional illustration of the melt transfer system 1, which is obliquely positioned by way of the oblique positioning device in such a way that the molten metal 17 has flown into a region located opposite the riser 8, and thereby exposes the first end 8.1 of the riser.

FIG. 10 shows the oblique positioning device 12 (at least partially). The oblique positioning device 12 comprises a base 12.2, which is pivotably hinged at two vessel-side flanges 12.3. The base 12.2 can thus be pivoted from a functional position into an idle position. FIG. 10 shows the base in an idle position. The vessel-side flanges 12.3 each include a first borehole 12.3.1, which in the functional position are positioned coaxially to a first base-side borehole 12.2.1. FIG. 10 (b) furthermore shows a locking pin 12.4, which locks the base 12.2 in the idle position. The vessel-side flanges 12.3 can each include a second borehole 12.3.2 through which the locking pin 12.2 is pushed so as to lock the base in the idle position. As is apparent from FIG. 10 (b), the vessel-side flange can comprise multiple flange regions, for example in the form of individual flanges. The expression “vessel-side flange” is used as a general concept for one or more flanges that are connected to the vessel. The base 12.2 furthermore includes a third base-side borehole 12.2.3 for locking the base to a supporting frame by way of a further locking pin.

FIG. 11 shows the vessel 2 including a supporting frame 12.1. The supporting frame 12.1 comprises a swivel joint unit 12.1.1, by way of which the vessel 2 is pivotably connected to the supporting frame 12.1 in such a way that the vessel 2 can be tilted about a rotational axis A of the swivel joint unit 12.1.1 in relation to the supporting frame 12.1, wherein the vessel 2 can be supported in the tilted position by the base 12.2 that is locked in the functional position.

FIG. 12 shows the supporting frame in a perspective view. In addition to the swivel joint unit 12.1.1, the supporting frame comprises a lower locking device 12.1.2, which includes two flanges, each including a borehole 12.1.2.1. The boreholes are coaxially aligned so that the base 12.2 can be fastened to the supporting frame 12.1 by the locking pin in the functional position. For this purpose, a further locking pin 12.4 can be pushed through the third base-side borehole 12.2.3 and the two boreholes 12.1.2.1 of the lower locking device. FIG. 13 shows the corresponding elements of the swivel joint unit 12.1.1, which are fastened, preferably welded, to the vessel. The vessel-side swivel joint unit 12.1.1 is arranged on an outer side at the vessel 2 opposite the base attachment in the form of the vessel-side flanges 12.3. The supporting frame comprises two box-shaped fork pockets 11, arranged so as to cross one another, for receiving forklift tines. The supporting frame furthermore comprises an alignment device for setting the supporting frame inclination in relation to a floor surface on which the supporting frame is arranged. This, however, is not shown in the figure.

FIG. 14 (a) shows the melt transfer system 1 of the above figures schematically on a forklift truck. The tines of the forklift truck are positioned in the fork pockets 11 in the process. So as to obliquely position the vessel 2, the melt transfer system 1 is raised off the floor by way of the forklift truck, for example 200 mm. The base 12.2 is pivoted by an operator 23 from an idle position into a functional position along the arrow 24 (see FIG. 14 (b)). The base 12.2 is locked in the functional position by way of the locking pin 12.4 (see FIG. 14 (c)).

FIG. 14 (d) shows the schematic illustration of the forklift truck 22 with the melt transfer system 1 with the folded-out base 12.2 in the functional position. In FIG. 14 (e), the transfer system 1 of FIG. 14 (d) is lowered so that the vessel 2 with the folded-out base 12.2, wherein the melt transfer system 1 is lowered so that the vessel is inclined in relation to a floor surface 25 by 5°. After the melt transfer system 1 has been lowered, the base 12.2 can be locked by way of the lower locking device 12.1.2 at the supporting frame 12.1 using a further locking pin 12.4, as described above (see FIG. 14 (f)).

FIG. 1 (d) shows the melt transfer system 1 in a perspective view. The melt transfer system 1 corresponds to that of the figures above. The burner unit 10.2 is fastened to a connecting flange 10.3 by clamping so that the burner 10.2.2 protrudes into the vessel interior space 7. The burner is preferably a gas burner by which the vessel interior space can be preheated. The connecting flange 10.3 projects upwardly from an upper side of the vessel cover 3 and is arranged in such a way that the burner 10.2.2 does not fire the riser 8 directly. The riser 8 is used as a chimney during preheating and is thus advantageously heated.

FIG. 1 (a) shows the melt transfer system 1 in a perspective view. The melt transfer system 1 corresponds to that of the figures above. In FIG. 1 (a), the heating opening is closed in an air-tight manner by the heating opening cover 10.1. For this purpose, the heating opening cover is fastened to the connecting flange 10.3 by clamping. The heating opening has a diameter of 9 cm and is round. The filling opening has a diameter of 60 cm, and the vessel cover has a diameter of 110 cm. The vessel cover and the filling opening cover are made of steel and lined with a refractory compound.

FIG. 15 shows the burner unit 10.2 in a perspective view. The burner unit 10.2 comprises a plug for supplying the burner with power. The burner unit 10.2 furthermore comprises a gas connector 10.5 for connecting gas, and an air connector 10.6 for connecting an air supply. A burner pipe 10.7 is arranged in a spatially separated manner from the connections 10.4, 10.5 and 10.6 by a burner connecting flange 10.2.1, so that the burner pipe 10.7 protrudes into the vessel 2 when the burner unit 10.2 is mounted to the connecting flange 10.3, while the connections are arranged easily accessible for an operator outside the vessel interior space 7 on a vessel cover upper side 3.2.

The application includes, among other things, the following aspects:
1. A melt transfer system, comprising a vessel for receiving molten metal, a flow duct for feeding the molten metal from a vessel through the flow duct, and a vessel cover for closing the vessel in an air-tight manner, and an oblique positioning device for tilting the vessel,
   characterized in that
   the oblique positioning device comprises at least one base connected to the vessel in an articulated manner and a vessel-side locking device for locking the base in a functional position, the base being movable from an idle position into a functional position, and protruding over a vessel underside in the functional position.
2. The melt transfer system according to aspect 1, characterized in that the vessel-side locking device comprises a detent, clamping or snap-fit mechanism or comprises a locking pin.
3. The melt transfer system according to aspect 2, characterized in that the vessel comprises a first flange including a first flange-side borehole, and the base includes a first base-side borehole, which is aligned coaxially to the first flange-side borehole in the functional position, and the locking pin can be pushed through the first flange-side borehole and the first base-side borehole for locking the base in the functional position.
4. The melt transfer system according to aspect 3, characterized in that the base includes a second base-side borehole, which is aligned coaxially to the first flange-side borehole in the idle position, so that the locking pin can be pushed through the first flange-side borehole and the second base-side borehole for locking the base in the idle position.
5. The melt transfer system according to any one of the preceding aspects, characterized in that the base can be pivoted from the idle position into the functional position.
6. The melt transfer system according to aspect 5, characterized by a fastening pin, which rotatably connects the base to the flange and along the fastening pin longitudinal direction of which a rotational axis is defined, about which the base can be pivoted from the idle position into the functional position, and vice versa.
7. The melt transfer system according to any one of aspects 3 to 6, characterized by a second flange, which is designed to correspond to the first flange, the base being arranged between the two flanges.
8. The melt transfer system according to any one of the preceding aspects, characterized by a supporting frame comprising a swivel joint unit, by way of which the vessel is pivotably connected to the supporting frame in such a way that the vessel can be tilted about a rotational axis of the swivel joint unit in relation to the supporting frame, the vessel being supported in the tilted position by the base that is locked in the functional position.
9. The melt transfer system according to aspect 8, characterized in that the supporting frame comprises a supporting frame-side locking device for locking the base in the functional position.
10. The melt transfer system according to aspect 9, characterized in that the base includes a third borehole, which is designed to receive a second locking pin in the functional position, the lower locking device including at least one supporting frame-side borehole, which is arranged coaxially with the third base-side borehole in the functional position so that the second locking pin can be pushed into the third base-side borehole and the supporting frame-side borehole of the lower locking device for fastening the base to the lower supporting frame.
11. The melt transfer system according to any one of aspects 8 to 10, characterized in that the supporting frame comprises at least one pair of, preferably box-shaped, fork pockets for receiving forklift truck tines.
12. The melt transfer system according to any one of the preceding aspects, characterized by an alignment device for setting a vessel inclination and/or a supporting frame inclination.
13. The melt transfer system according to any one of the preceding aspects, characterized by
   a measuring unit comprising at least one pressure sensor for measuring a pressure in the vessel during the feeding, and
   a control unit for controlling the feeding of the molten metal out of the vessel through the flow duct, the control unit being configured and designed to halt the feeding of the molten metal in the event of a drop of the measured pressure,
and/or
in that the vessel cover includes a filling opening for filling the vessel with molten metal, a filling opening cover for closing the filling opening in an air-tight manner, a heating opening comprising a connecting flange surrounding the heating opening for flange-mounting a preheating device and for flange-mounting a heating opening cover, and a heating opening cover for closing the heating opening in an air-tight manner, the heating opening cover being detachably fastened to the vessel cover and closing the heating opening in an air-tight manner.
14. A method for tilting a vessel of a melt transfer system according to any one of aspects 1 to 13, comprising the following steps:
   raising the device by at least 5 cm;
   bringing the base from an idle position into a functional position so as to protrude over an underside of the vessel;
   locking the base in the functional position; and
   lowering the melt transfer system.
15. The method according to aspect 14, to the extent that this aspect has a back-reference to aspect 9, comprising the following step:
   locking the base by way of the supporting frame-side locking device.
16. A melt transfer system, comprising a vessel for receiving molten metal, a flow duct for feeding the molten metal from a vessel through the flow duct, and a vessel cover for closing a vessel interior space in an air-tight manner,
   characterized in that
   the vessel cover includes a heating opening, comprising a connecting flange surrounding the heating opening for flange-mounting a preheating device and for flange-mounting a heating opening cover, and a heating opening cover for closing the heating opening in an air-tight manner, the heating opening cover being detachably fastened to the vessel cover and closing the heating opening in an air-tight manner.
17. The melt transfer system according to aspect 16, characterized in that the heating opening has a diameter of at least 4 cm, and preferably at least 6 cm, and/or a diameter of no more than 30 cm, and preferably no more than 20 cm.
18. The melt transfer system according to aspect 16 to 17, characterized in that the vessel cover comprises
   a filling opening for filling the vessel with molten metal, and a filling opening cover for closing the filling opening in an air-tight manner, and/or
   a filling device for filling the vessel through the flow duct.
19. The melt transfer system according to aspect 16, 17 or 18, characterized in that the vessel cover has a diameter of at least 50 cm, and preferably at least 70 cm.
20. The melt transfer system according to any one of the preceding aspects, characterized in that the heating opening cover is fastened to the vessel cover by way of clamps and/or screws.
21. The melt transfer system according to any one of the preceding aspects, characterized in that the heating opening cover comprises a refractory layer.
22. The melt transfer system according to any one of the preceding aspects, characterized in that the connecting flange projects from a cover upper side in such a way that a flange plane is spaced apart from the cover upper side, the flange plane preferably having a distance of at least 10 mm, and particularly preferably at least 30 mm.
23. The melt transfer system according to aspect 22, characterized in that the flange plane forms an angle with the cover upper side of at least 109, preferably at least 20°, and particularly preferably at least 30°, and/or of no more than 90′, preferably no more than 80, and particularly preferably no more than 70°.
24. The melt transfer system according to any one of the preceding aspects, characterized in that the heating opening cover comprises a handle.
25. The melt transfer system according to any one of the preceding aspects, characterized in that the heating opening cover comprises a blind flange for closing the heating opening.
26. The melt transfer system according to any one of the preceding aspects, characterized in that the connecting flange is designed in such a way that a corresponding flange of a preheating device, and in particular of a gas burner or of an electronic heating element, for preheating the vessel interior space can be flange-mounted on the flange by way of clamps or screws.
27. The melt transfer system according to aspect 26, characterized in that the connecting flange is designed in such a way that a gas flame of a flange-mounted gas burner is aligned in the direction of the vessel bottom, and preferably the middle of the vessel bottom.
28. The melt transfer system according to aspect 26 or 27, comprising a burner cover, comprising a preheating device, preferably a gas burner, comprising a flange that corresponds to the connecting flange of the heating opening.
29. The melt transfer system according to any one of the preceding aspects, characterized by an oblique positioning device for tilting the vessel, the oblique positioning device comprising at least one base connected to the melt transfer system in an articulated manner and a vessel-side locking device for locking the base in a functional position, the base being movable from an idle position into a functional position, and protruding from a vessel underside in the functional position.
30. The melt transfer system according to any one of the preceding aspects, characterized by
   a measuring unit comprising at least one pressure sensor for measuring a pressure in the vessel during the feeding, and
   a control unit for controlling the feeding of the molten metal out of the vessel through the flow duct, the control unit being configured and designed to halt the feeding of the molten metal in the event of a drop of the measured pressure.
1 melt transfer system
2 vessel
3 vessel cover
3.1 vessel cover underside
3.2 vessel cover upper side
4 filling opening
5 filling opening cover
5.1 gas tension springs
6 pneumatic unit
6.1 pneumatic line
7 vessel interior space
8 riser
8.1 first end of the riser
8.2 second end of the riser
9 thermocouple
10 heating opening
10.1 heating opening cover
10.2 burner unit
10.2.1 flange of the burner unit
10.2.2 burner
10.3 connecting flange
10.4 plug
10.5 gas connector
10.6. air connector
10.7 burner pipe
11 fork pockets
12 oblique positioning device
12.1 supporting frame
12.1.1 swivel joint unit
12.1.2 lower locking device
12.1.2.1 borehole in the lower locking device
12.2 base
12.2.1 first base-side borehole
12.2.2 second base-side borehole
12.2.3 third base-side borehole
12.3 vessel-side flange
12.3.1 first borehole on vessel-side flange
12.3.2 second borehole on vessel-side flange
12.4 locking pin
12.5 pivot pin
13 refractory compound
14 insulating layer
15 outside cladding
16 control unit
17 molten metal
17.1 molten metal level
18 air
19 gap
19.1 fgap height
20 pressure profile p(t)
21 time derivative dp/dt
21f time derivative dp/dt filtered
22 forklift truck
23 operator
24 pivot direction
25 floor surface
26 vertical distance between floor surface and melt transfer device
A rotational axis

1-15. (canceled)

16. A method for emptying a melt transfer system, comprising a vessel for receiving molten metal, a flow duct, including a riser, for feeding the molten metal from a vessel through the flow duct, and a vessel cover for closing the vessel in an air-tight manner, comprising the following steps:
i. feeding the molten metal from the vessel through the flow duct;
ii. determining a pressure in the vessel during feeding; and
iii. halting the feeding of the molten metal in the event of a drop of the measured pressure.

17. The method according to claim 16, wherein the feeding of the molten metal is halted when a pressure difference between a pressure determined at a first point in time and a pressure determined at a second point in time is negative, the negative pressure difference preferably being greater, in absolute terms, than a previously established threshold value.

18. The method according to claim 16, wherein a time profile over time is determined based on the measured pressure, and a time derivative dp/dt of the pressure profile is ascertained based on the time profile over time, and the feeding of the molten metal is halted when the derivative dp/dt is negative, the negative derivative, in absolute terms, being greater than a previously established threshold value.

19. The method according to claim 18, wherein the threshold value, in absolute terms, is at least 1 mbar/s, including at least 5 mbar/s, and at least 10 mbar/s.

20. The method according to claim 16, wherein a second pressure is measured at a second location, the second measured pressure correlating with a pressure in the vessel, with a pressure in the pneumatic unit for setting a pressure difference between an ambient pressure and a pressure in the vessel and/or with a pressure in the flow duct.

21. The method according to claim 16, wherein the pressure profile over time is measured based on pressure measurements at defined time intervals.

22. The method according to claim 18, wherein in each case at least two, and including at least three, consecutively measured pressures are averaged and the time derivative is ascertained based on the averaged pressures
and/or
a frequency of the pressure profile over time is filtered using a bandpass filter.

23. The method according to claim 16, wherein a pressure difference between the first, vessel-side end and the second end of the flow duct is reduced for halting the feeding of the molten metal, as soon as the ascertained derivative of the pressure profile is negative and, in absolute terms, is greater than a previously established threshold value.

24. A melt transfer system for storing and transporting molten metal, comprising:
a vessel for receiving the molten metal;
a vessel cover, arranged on the vessel, for closing the vessel in an air-tight manner, comprising a closable filling opening for filling the vessel with the molten metal;
a flow duct, comprising a first end arranged in the vessel, and a second end arranged outside the molten metal vessel for feeding the molten metal from the molten metal vessel;
a measuring unit comprising at least one pressure sensor for measuring a pressure in the vessel during the feeding; and
a control unit for controlling the feeding of the molten metal out of the vessel through the flow duct, the control unit being configured and designed to halt the feeding of the molten metal in the event of a drop of the measured pressure.

25. The melt transfer system according to claim 24, wherein the control unit is designed and configured to determine the time profile over time p(t) from the measured pressure, to ascertain a time derivative of the pressure profile dp/dt, and to halt the feeding of the molten metal when the derivative of the pressure profile dp/dt is negative, and when the derivative, in absolute terms, is greater than a previously established threshold value.

26. The melt transfer system according to claim 24, wherein the control unit is designed and configured to reduce a pressure difference between the first, vessel-side end and the second end of the flow duct for halting the feeding of the molten metal,
and/or
the threshold value, in absolute terms, is at least 1 mbar/s, including at least 5 mbar/s, and at least 10 mbar/s.

27. The melt transfer system according to claim 25, wherein the control unit is designed and configured to average in each case at least two, and including at least three, pressures measured consecutively by the measuring unit and to ascertain the derivative based on the averaged pressures.

28. The melt transfer system according to claim 24, wherein the at least one pressure sensor is arranged on an inner side of the vessel cover and/or in a pneumatic unit.

29. The melt transfer system according to claim 24, further comprising an oblique positioning device for tilting the vessel, the oblique positioning device comprising at least one base connected to the melt transfer system in an articulated manner and a vessel-side locking device for locking the base in a functional position, the base being movable from an idle position into a functional position, and protruding over a vessel underside in the functional position.

30. The melt transfer system according to claim 24, wherein the vessel cover includes a filling opening for filling the vessel with molten metal, a filling opening cover for closing the filling opening in an air-tight manner, a heating opening, comprising a connecting flange surrounding the heating opening for flange-mounting a preheating device and for flange-mounting a heating opening cover, and a heating opening cover for closing the heating opening in an air-tight manner, the heating opening cover being detachably fastened to the vessel cover and closing the heating opening in an air-tight manner.
